(19) United States
(12) Patent Application Publication
(10) Pub. No.: US 2004/0040516 A1
(43) Pub. Date: Mar. 4, 2004

(54) Method of reducing emission of ammonia from animal manure, a plant for performing the method and a use of such plant

(76) Inventor: Jens Ostergaard Jensen, Vodskov (DK)

Correspondence Address: HARNESS, DICKEY & PIERCE, P.L.C., P.O. BOX 8910, RESTON, VA, 20195, US

(21) Appl. No.: 10/399,171

(22) PCT Filed: Oct. 16, 2001
(86) PCT No.: PCT/DK01/00685

(30) Foreign Application Priority Data
Oct. 16, 2000 (DK) PA 2000 01541

(51) Int. Cl. A01K 1/00

(52) U.S. Cl. 119/416; 119/447

(57) ABSTRACT

The invention relates to a method of reducing emission of ammonia from animal manure and a plant for the method and a used of such a plant. The method comprises adding to the manure of both an acid compound such as sulphuric acid, H2S04, and of oxygen, O2. The acid compound results in the pH value dropping to below 7.0 whereby the emission of ammonia is substantially limited. The oxygen results in a very high activity of bacteria transforming organic nitrogen compounds to in-organic compounds that are possible for plants to assimilate when manure is spread in fields. Surprisingly, it has also should to be the case that the oxygen added, and thus the enhancing of the activity of the bacteria. results in a reduction of the amount of acid compound needed to he added and results in reducing, almost eliminating, the risk of hydrogen sulphide, H2S, being formed.

The present invention relates to a method of reducing emission of ammonia from animal manure, said manure containing ions of ammonium NH₄⁺and having a pH value above 7, and said manure being added an acid compound having a pH value below 7, and where the acid compound is added to the manure after the manure has been led from a manure gutter to a collection vessel. The invention also relates to a plant for performing the method and relates to a use of such a plant.

EP 0 850 561 describes a system for reducing the emission of ammonia dust and odeur at the same time. A storage reservoir is provided with acidification means for adding an acid such as sulphuric acid to the liquid fraction of the manure in the storage reservoir. Thereby the manure may be acidified to a pH of less than 6 and fed back to the manure collection channels. The fresh manure entering the collection channels then enters an acidic environment, thus limiting the discharge of ammonia, NH₃. Also described is an air removal channel in order to mix the animal-shed air with the acidified liquid manure in order to purify the air being ventilated form the animal-shed.

EP 0 498 084 also describes the possibility of acidifying the liquid fraction of manure, however, in order for the pH of the manure being so that the manure may used to clean the livestock house. Before the liquid fraction of the manure possibly is acidified and filtered, the combined liquid fraction and solid fraction is dried by means of the ventilating air in the livestock house. Thereby the solid fraction is 30% or more. During the aeration a large amount of fluid is extracted form the urine and the faeces so that the water content of the faeces fraction and the volume of the urine are reduced.

WO 95/12971 furthermore describes a stable provided with means for adding of an acid to the manure and afterwards using the acidified manure to flush gutters in the stable. One of the purposes of the stable described in this publication is to reduce the emission of ammonia. The manure having a pH value above 7.0 is added an acid so that the pH value is decreased to a value of 6.0 or lower. The ammonia-ions in the manure are bound to the negatively charged ions of the acid, and thereby the amount of free ammonia emitted from the gutters is limited due to the decrease of non-bounded ammonia-ions.

However, some disadvantages occur when using the methods and systems described in the above-mentioned publications. Firstly, flushing of the gutters with the acidified manure may cause aerosols of ammonia to occur. These aerosols being small droplets of ammonia may be more irritating to the animals and persons situated in the stable than the mere ammonia-vapour normally occurring. Secondly, reducing the evaporation of ammonia in an animal-shed by adding an acid to the liquid fraction of the manure and then feeding the acidified manure back to the collection channels results in that the amount of sulphuric acid being added will have to be constantly increased in order to maintain the same and low level of evaporation of ammonia. If the chemical composition of the manure is the same whenever manure is led from the gutters to a manure reservoir, then the same amount of acid have to be added continuously, thus resulting in a high consumption of acid.

Thirdly, there is a great risk of hydrogen sulphide, H₂S, being formed if as example sulphuric acid is being used as the acid. To the person skilled in the art, sulphuric acid will be a highly recommended acid to add to the manure because sulphuric acid is easy to produce and is cheap to buy. However, hydrogen sulphide, H₂S, is a very bad smelling and a highly flammable compound, if ignited. Also, because of hydrogen sulphide being heavier than atmospheric air, if hydrogen sulphide is generated, there is a risk of the animals in the stable being suffocated.

It is an object of the present invention to remedy the disadvantages of the above-mentioned prior art and to provide a method and a plant for performing the method that are capable of reducing the emission of manure, not only in an efficient manner but also in an economical manner. It is also an object to provide a method and a plant that are capable of, at the same time, reducing the emission of ammonia and optimising conversion of plant accessible nitrogen in the manure.

This object is obtained by a method where the manure furthermore is being added oxygen after the manure has been led from the manure gutter, and where the acidified and oxidized manure having been added both the acid compound and the oxygen afterwards is being led back to the manure gutters.

By also adding oxygen to the manure, several advantages have shown to be present. Some of the advantages are not present if only oxygen is added to fresh manure, but is only present if the oxygen is added to acidified manure. One advantage is that conversion of organic substances to inorganic substances is enhanced. This, the person skilled in the art may have been able to deceive, however, not when the conversion takes place in an acid environment such as the acidified manure. In the present invention, due to the effect of reducing the emission of ammonium by acidifying the manure, the person skilled in the art would think that this will lead to an increase in the amount of organic ammonia, thus increasing the risk of pollutive effects of the manure if and when spread on agricultural fields, because of the non-accessibility of the organic nitrogen to plants. However, surprisingly it has been shown that this effect is not present. This is due to the adding of oxygen to the manure, the oxidation resulting in the formation of a certain amount of urea, which, although being an organic nitrogen-containing compound, is accessible to plants. Also, because of adding of oxygen to the manure, amino acids are transformed to urea. Contrary to this, if no oxidation is established, then the amount of organic and non-accessible nitrogen would be much greater.

Thus, actually there is a discrepancy between the adding of an acid compound leading to an increase in the amount of nitrogen in the treated manure, and the adding of oxygen leading to an increase in the amount of ammonia emitted from the manure. However, according to the method of the present invention, it is possible to combine the two compounds and achieve the advantage of a surprising synergetic effect.

Another advantage is that the risk of hydrogen sulphide, H₂S, being generated is eliminated or at least limited to a level below a level of nuisance due to the bad-smelling of the hydrogen sulphide and below a level of danger due to the risk of fire starting, if ignited. An even further advantage which has been surprisingly found during tests in a stable is that the amount of acid compound to be added may be constantly reduced in relation to the number of times that manure is led to the collecting vessel such as a collection tank or annular canals running through the stable, and in which tank or canals the manure may stay for a shorter or longer period of time, and acidified and oxidized manure is led back to the manure gutters.

However, theoretically there is always a risk of hydrogen sulphide to develop if sulphuric acid is used as the acid compound and if not the adding of oxygen to the manure is sufficient. The chemical process for developing hydrogen sulphide is

SO₄²⁻+Desulfovibrio(bacteria)→H₂S

Therefore, the plant according to the invention may comprise an alarm for alerting if the amount of hydrogen sulphide is to high in comparison to a satisfactory low level. The alarm may be combined with other alarms related to monitoring the stable and the equipment in the stable.

By a preferred method, the acid compound is added in the collection vessel after the manure has been led to the collection vessel and before the acidified manure is led back to the manure gutters, and the oxygen is added to the manure after the manure has been led from the collection vessel and before the acidified and oxidized manure is led back to the manure gutters.

By adding the acid compound in the collecting vessel, the acid may be added under conditions where the manure is settled and measuring of the pH value can be made accurately. Contrary to this, adding of the oxygen is best performed when the acidified manure flows through distribution means so that the oxygen is effectively mixed with the acidified manure. Adding of the oxygen may take place either by means of an ejector provided in the distribution means or by means of a compressor blowing air into the distribution means.

Preferably, the acidified and oxidized manure being led to the manure gutters has a pH value of between 3.0 and 7.0, preferably between 4.0 and 6.0, more preferably a pH value of 5.5, and has a content of oxygen of between 0.4 mg/l and 5.0 mg/l, preferably. between 0.5 mg/l and 2.0 mg/l, more preferably 1.0 mg/l.

Within these values it is assured that the advantages and the desired technical effects can be obtained. The advantages are more pronounced and the technical effects are greater when using the preferred values or the more preferred values.

By a preferred method, manure from the manure gutters is being mixed with manure that has been initially collected in the collection vessel and subsequently has been acidified and oxidized, and the mixture of the non-acidified and the non-oxidized manure together with acidified and the oxidized manure is being recycled in such a way that a number of times the mixture is being led from the manure gutters to the collection vessel for adding of the acid compound and adding of the oxygen and subsequently is being led from the collecting vessel to the manure gutters, and an amount of acid compound added before the mixture is being led from the collecting vessel to the manure gutters may be decreased relative to the number of times that the mixture has been cycled by being led from the manure gutters to the collection vessel.

Preferably, the manure is led from the manure gutters to the collection vessel and subsequently acidified and oxidized and finally led back to the manure gutters more than once. This results in that after a first cycle of manure, then the manure taken from the manure gutters will be a mixture of fresh manure and the cycled manure being acidified and oxidized. However, surprisingly it has been found that the amount of acid that has to be added in order to keep the manure in the collecting vessel at a certain low pH value is decreasing in relation to the number of times that the manure is cycled between the manure gutters and the collection vessel although fresh manure is mixed into the cycled manure every time the manure is led to the manure gutters.

The reason for this is not at present precisely known, but one theory is that aerobic micro-organisms that are used for converting organic substances to in-organic substances develop one or more acid compounds during their respiration and conversion. These acid compounds developed by the micro-organisms also lowers the pH value and is also used for bonding the ammonia-ions, thus reducing the emission of ammonia. The acid compounds developed by the micro-organisms is most likely lactic acid, CH₃CH(OH)COOH, acetic acid, CH₃COOH, and formic acid, HCOOH. The effect of the acid compound being added in the collection vessel decreasing because of aerobic micro-organisms developing supplementary acid compounds can probably only be obtained when the manure is oxidized, because the oxidation increases the activity of the aerobic micro-organisms.

A plant according to the invention comprises a collection vessel for collecting animal manure being led from manure gutters in a stable, and said plant furthermore comprises acid supply means for adding an acid compound to the manure and oxygen supply means for adding oxygen to the manure, and said plant furthermore comprises distribution means for distributing the acidified and oxidized manure back to the manure gutters in the stable and which distribution means is situated between the collecting vessel and a number of outlets of the distributing means.

A plant being fitted with means both for adding an acid compound and for adding of oxygen involves synergetic effects to the technical effect of the manure distributed by the plant, effects which have not yet been possible to envisage. The synergetic effects are described more in detail in relation to the above brief description of the method according to the invention. The theoretical basis of the invention lies in simple chemical relations. There will always be equilibrium between dissolved ammonium, NH₄⁺, and the content of ammonia, NH₃, in the air. This equilibrium will be shifted under alteration of the pH value. During tests experiments are made lowering the pH value. The results show that at a pH value of 5.0 emission of ammonia excised. At a pH value of 5.5 only a minimal emissionof ammonia occurs. During the tests it was envisaged that a part of the emission of ammonia occurs just after the manure from the animals lands on the floor of the pen. The chemical process is the following:

CO (NH₂)₂+H₂O+urease→(NH₄)₂CO₃→2 NH₃+CO₂+H₂O

The micro organisms constituted by bacteria which produce urease are sensitive to pH values and are very little active at pH values below 5.5. Thus, the chemical process may be limited by lowering the pH value on the floor to pH values below 5.5.

A preferred embodiment of the plant is provided with acid supply means for adding the acid compound to the collection vessel, and preferably to the bottom of the collecting vessel, and the plant is provided with acid supply means comprising a valve being installed between a reservoir for the acid compound and the collecting vessel for the manure, and where adding of the acid compound from the reservoir through the valve to the collecting vessel is regulated by a pH sensor situated in the collecting vessel.

Using a pH sensor to regulate the adding of the acid compound from an acid supply makes it possible to fully automate the adding of the acid compound, without the need to control or monitor the adding of the acid compound. There is only a need for controlling that the acid supply means such as a large vessel containing the acid compound is not running dry.

A preferred embodiment of the distribution means of the plant comprises a pump installed in the collecting vessel, preferably an emerged pump being installed at the bottom of the collecting vessel, and where the distribution means comprises outlets being submerged below a surface of liquid manure being gathered and standing a certain depth in the manure gutters.

Using a submerged pump for pumping the acidified manure from the as example a collecting tank to the manure gutters and having outlets of the distribution means placed below a surface of a liquid part of the manure in the manure gutters ensures that no aerosols are being formed and spread in the stable when the manure is distributed to the manure gutters, thus improving the environment in the stable.

A further preferred embodiment of the distribution means of the plant comprises a number of transfer pipes constituting passages from a main pipe of the distribution means to the outlets of the distribution means, and where the transfer pipes extend from the main pipe upwards along a curve to an upper level and extend from the upper level downwards along a curve to the outlets, and where the upper level of all the number of transfer pipes lie in the one and same horizontal plane so that the liquid pressure of the acidified and oxidized manure in the outlets is the one and same.

Having transfer pipes from a main pipe and letting the pipes extend along an upwardly orientated curve and downwards to the outlets, and furthermore maintaining an upper level of the number of transfer pipes at the one and same horizontal level makes it simple and easy to have the same amount of acidified and oxidized manure being led to different manure gutters. This can be done irrespective of where the acidified and oxidized manure is being let into the main pipe and, thus there is no need to regulate the transfer of acidified and oxidized manure from the main pipe to the outlets by means of valves, different dimensions of the transfer pipes or other means for ensuring equal amount of acidified and oxidized manure being led to the different manure gutters.

A plant for reducing emission of ammonia from manuring areas in the stable comprises acid supply means for adding an acid compound to water, and said plant furthermore comprising distribution means for distributing the acidified water to a manuring area of the stable and which distribution means is situated between an inlet of water and a number of outlets of the distributing means. In a preferred embodiment of this plant the water pipe is running above the floor and above the pens at a certain height. This has the advantageous effect, that particles of dust in the air above the pens will be caught by the acidified water flushing the pens. Catching of the dust-particles by the water takes place both “mechanically” by the droplets of acidified water colliding with dust-particles, but also takes place “electrically” by the negatively charged ions in the acidified water attracting the often positively charged dust-particles.

The invention will now be described in more detail with reference to the accompanying drawings, where

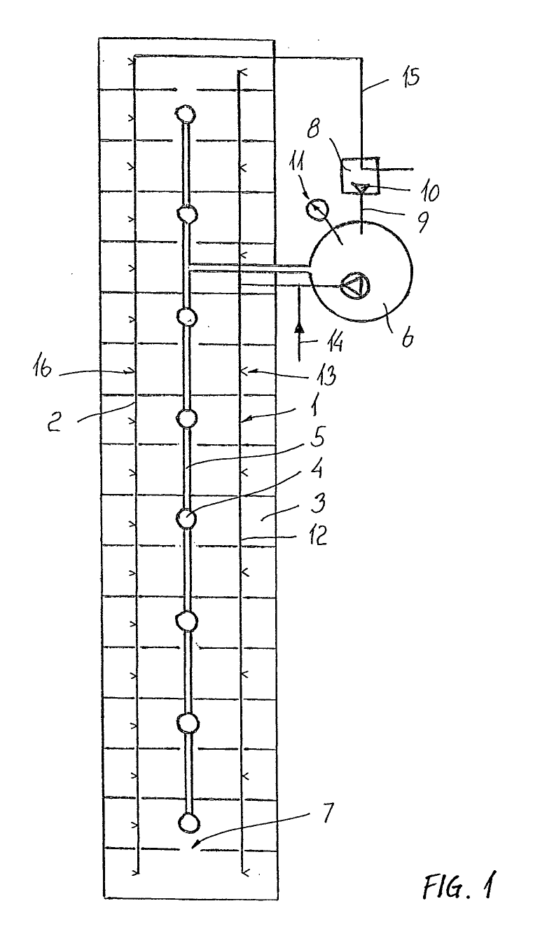

FIG. 1 is a schematic view of a plant for reducing emission of ammonia from manure butters and from a manuring area on a floor for animals in a stable,

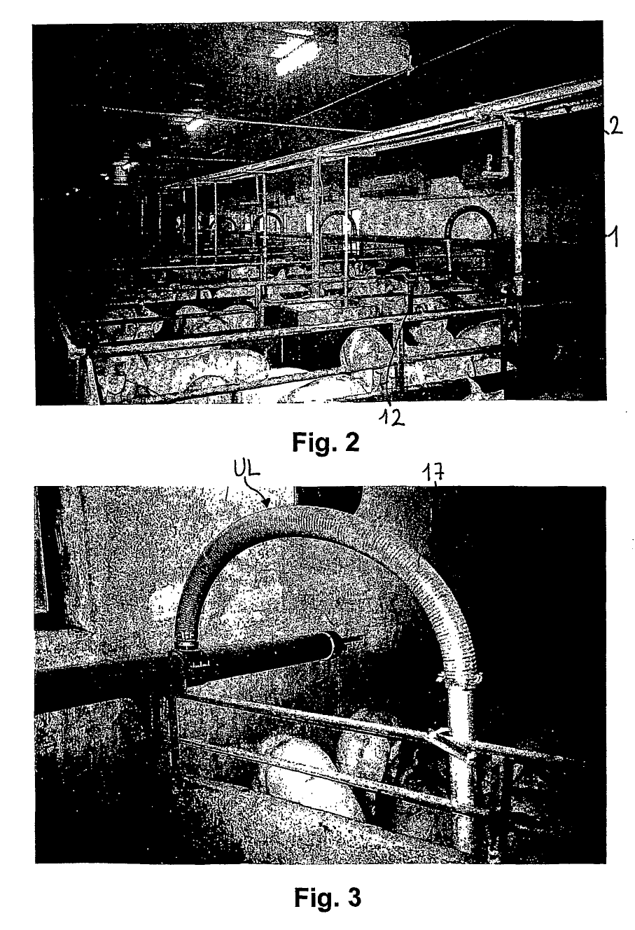

FIG. 2 is a photograph showing the plant installed in a stable for pigs, the plant comprising both means for reducing emission of ammonia

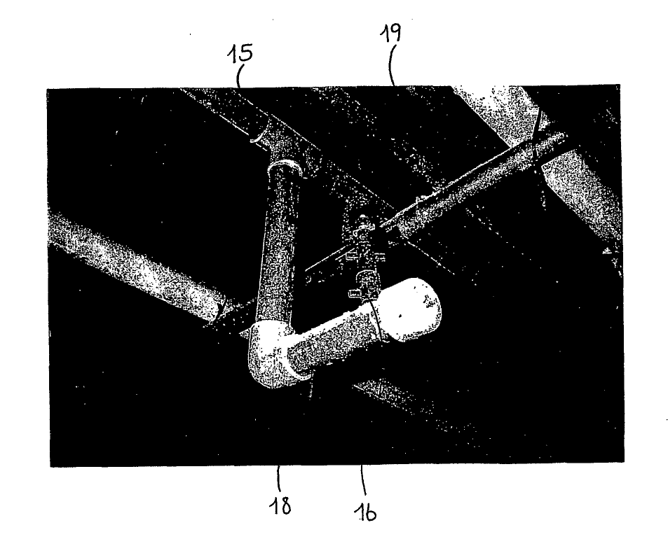

FIG. 3 is a photograph showing a detail of the plant, the detail being a part of the plant for distributing treated manure to the manure gutters, and

FIG. 4 is a photograph showing a detail of the plant, the detail being a part of the plant for distributing treated water to the manuring areas of the stable floor

FIG. 1 shows a possible plant for performing the method according to the invention. The plant is provided with a first part 1 with means for reducing emission of ammonia from manure gutters and a second part 2 with means for reducing emission of ammonia from manuring areas. The plant is installed in a stable. The stable comprises pens 3 for husbandry animals. The pens 3 are provided with a floor (see FIG. 2), and preferably the floor is elevated in relation to manure gutters being provided under the floor and the floor being provided with grits (see FIG. 2) through which manure from the animals may flow into the manure gutters under the floor.

The manure gutters are provided with drains 4 for leading the manure from the gutters through drainpipes 5 to a common collection vessel 6, the vessel being a tank in the embodiment shown. Alternatively, the collecting vessel could be a system of canals running through the stable and in which canals the manure stays for a period of time before being led to an outlet of the canals. In the embodiment of the stable shown, only each second gutter is provided with an outlet 4. Between gutters having a drain 4 and gutters not having a drain a passage 7 is established between the gutters so that gutters not having a drain may communicate with gutters having a drain and thereby the manure from gutters not having a drain may be drained also. The fresh manure drained from the gutters is led to the common collection tank 6.

The first part 1 of the plant is provided with means for adding an acid compound to the manure and is also provided with means for adding of oxygen to the manure. When collected in the collection tank 6, the fresh manure is being added an add compound. A reservoir 8 for the acid compound is placed nearby the collection tank 6. A tube 9 leads from the reservoir 8 for the acid compound to the collection tank 6 and preferably to the bottom of the collection tank. A valve 10, preferably a motor-regulated valve, is installed between the reservoir 8 and the collection tank 6 just before or along the tube 9 leading to the collection tank. A pH sensor 11 is installed in the collection tank 6 at a proper level so that the pH sensor is capable of sensing the pH value of the manure in the collection tank. The manure when initially being led to the collection tank has a pH value above 7.0 and it is an object to lower the pH value to a value below 7.0. This is accomplished by adding the acid compound to the manure.

Adding of the acid compound is regulated by the pH sensor 11 and by the valve 10. The pH sensor 11 is programmed to a certain pH value of between 3.0 and 7.0, preferably between 4.0 and 6.0, more preferably a pH value of 5.5. As long as the pH value is above the pH value that the pH sensor 11 is programmed for, the valve 10 is opened in order to add the acid compound from the reservoir 8 through the tube 9 to the collection tank 6. When the pH value reaches the pH value that the pH sensor 11 is programmed for, then the valve 10 is closed. In the collection tank 6 the fresh manure has now been acidified. Subsequently the manure is to be oxidized.

Distribution means are provided for distributing the acidified manure from the collection tank 6 to the manure gutters. The distribution means comprises a main pipe 12 leading from the collection tank and along the pens. Through outlets 13, the manure from the collection tank 6 is led from the main pipe 12 to the manure gutters. The main pipe 12 is provided with the means 14 for adding of oxygen to the acidified manure from the collection tank 6. The means 14 for adding of oxygen may be an ejector provided in the main pipe 12 for sucking of oxygen or atmospheric air into the main pipe. The means 14 for adding of oxygen may also be a compressor for blowing of oxygen or atmospheric air into the main pipe.

As mentioned, the plant also comprises means 2 for reducing emission of manure from manuring areas on the floor at which the husbandry animals stand and lie. These means consist of a water pipe 15 leading past the reservoir 8 for the acid compound and further on to manuring areas in the stable. The water is being led past the reservoir 8 in order to have an amount of the acid compound mixed with the water. Thereby, the water is acidified and is being led to outlets 16 established in each pen 3. The outlets 16 are established above the floors in the pens so that a certain area of the floors may be flushed with the acidified water.

The animals standing and resting in the pen may not have a certain manuring area in the pen. However, the parts of the floor in the pen which is being flushed with the acidified water will often for many species of husbandry animals be chosen as the manuring area, probably because the area is wet. Thus, if the animals do not have a manuring area of their own choice, then the area being flushed may become the preferred area to manure.

FIG. 2 is a photograph of a stable installed with both the first part and the second part of the plant. The first part of the plant comprises the distribution means consisting of the main pipe 12 running along one of the walls of the stable, the outlets (not shown) and transfer pipes 17 (see also FIG. 3) established between the main pipe 12 and the outlets 13.

The second part of the plant comprises the water pipe 15 running above the pens of the stable and outlets 16 (see also FIG. 4). The outlets 16 are provided along side pipes extending from the main water pipe 15 and the reason for the outlets being provided above the pens is firstly, that a relatively large area of the floors in each pen may be flushed by the acidified water from the outlets. Secondly, flushing from a position above the pens has the effect that particles of dust in the air above the pens will be caught by the water flushing the pens. Catching of the dust-particles by the water takes place both “mechanically” by the droplets of acidified water colliding with dust-particles, but also takes place “electrically” by the negatively charged ions in the acidified water attracting the often positively charged dust-particles.

FIG. 3 is a photograph showing the main pipe 12 of the first part of the plant, and a transfer pipe 17 leading from the main pipe 12 to an outlet (not shown). The main pipe 12 leads from the collection tank 6 and along the different pens in the stable (see FIG. 1). The transfer pipe 17 extends from an upper part of the main pipe 12 upwards along a curve to an upper level UL and further on downwards along a curve to the outlet (not shown). The outlet is positioned underneath the floor F in the pen, and is preferably positioned underneath a surface of liquid manure standing a certain height in the manure gutters under the floor. Thereby, when the acidified and oxidized manure is being led to the outlets, then there is no risk of flushing or any other actions, which may cause droplets of the manure developing.

The upper level UL of the transfer pipe is established at a certain horizontal level. All the transfer pipes (see FIG. 2) to the different pens have upper levels established at the one and same horizontal level (see FIG. 2). This feature in combination with the feature that the transfer pipes lead from an upper part of the main pipe has the effect, that the amount of acidified and oxidized manure being led from the main pipe via the transfer pipes and outlets to the manure gutters will be the same irrespective of whether the manure gutter is placed near or far from where the main pipe leads from the collection tank.

FIG. 4 shows an outlet from the water pipe 15 of the second part of the plant. The outlet 16 is established in a side branch 18 of the main water pipe, and a sprinkler 19 is provided as the outlet. The sprinkler 19 is designed to flush a selected section of the floor in a pen. The main pipe 15 and the sprinkler 19 are provided at a certain height over the pens, the height being at least the height of a person. Thus, the dust-particles caught by the acidified water flushing the pens will be caught in a height above the level of persons and pigs being present in the stable.

Results from test made of the plant according to the invention will now be presented and discussed with reference to the tables and discussions below.

Measurements and Analyses:

Initial tests are made where in a laboratory atmospheric air is blown into manure contained in a large measuring glass of approximately 2 l. Blowing takes place momentary with 2 minutes of blowing during a quarter of an hour. The pH value of the manure is constantly controlled and regulated to a pH value of 5.0. Subsequent analyses determine that the process as tested is possible, and that 91% of the nitrogen in the manure after treatment is in-organic, and thus plant accessible, compared to only 65% of the nitrogen in the non-treated manure being in-organic.

Also full scale tests are made. The tests are made in a pen with space for 25 pigs. The pen is pen with concrete grates with shielding made of concrete. The manure is kept in a manure gutter underneath the grates. The manure gutter has a depth of 0.5 m and has a manure capacity of 3.25 m³. In the manure gutter there is a manure capacity for 3 weeks. As reference a neighbouring pen is used med dimensions and layout corresponding to the test pen. Also the flooring is the same. The pigs in the reference pen are of the same size as in the test pen. Part of the manure is drained from the gutter twice an hour in a period of time of 1 min. The pump is a submerged pump “Flygt® 3000”. Thereby manure is pumped from the bottom of the gutter through a drainage to the collecting tank. At the same time sulphuric acid is added to the collecting tank. The amount of sulphuric acid, H2SO₄ (96%), added is 0.675 percentage of weight compared to the amount of manure. The manure added the sulphuric acid is flushed through a nozzle to the manuring area of the pen. Thus, two advantages are accomplished in the one and same process.

1. The urease producing bacteria on the manuring area are impeded. Thereby, the not wanted process: CO(NH₂)₂+H₂O+urease→(NH₄)₂CO₃→2NH₃+CO₂+H₂O

2. The manure in the manure gutters is kept at a pH value of about 5.0.

During the test period emission of ammonia is constantly measured over the test pen by means of a measurement apparatus Drager Accura. As an average of all measurements a content of ammonia (NH₃) above the flooring in the test pen of 1 ppm corresponding to 0.71 mg NH₃ per m³ of air. In the reference pen there is a corresponding average of 13 ppm corresponding to 9.23 mg NH₃ per m³ of air. Thus, the treatment resulted in the emission of ammonia being 13 times as small. After the manure gutters in the test pen and the reference pen, respectively, are filled, representative samples are taken and analysed. In accordance with the above-mentioned tests of the air, there is a much higher content of nitrogen in the manure from the treated pen in relation to the non-treated pen, namely 6400 mg(N)/l compared to 5100 mg(N)/l.

During the tests the content of hydrogen sulphide, H₂S, is measured with a DrägerAccura measurement apparatus. During none of the measurements is hydrogen sulphide present. The amount of oxygen, O₂, in the manure is constantly measured in the test pen as well as in the reference pen. The measurements are made with an oxygen sensor YSI 55. The average of daily measurements over a period of three weeks is that the content of oxygen in the test pen is 0.45 mg oxygen, O₂, per litre of manure while the content of oxygen in the reference pen is 0.09 mg oxygen, O₂, per litre of manure. Thus, there is a remarkable difference in the content of oxygen in the two pens. With reference to studies among the technical literature it is assumed that the content of oxygen, O₂, shall be about 1.00 mg oxygen, O₂, per litre of manure.

Test results of tests in pen:

| | Test pen | | Difference | Reference pen | |
|---|---|---|---|---|---|
| Measured content of | 1.2 | ppm | >8.0 ppm> | 9.2 | ppm |
| ammonia NH₃ in the air | | | | | |
| Analysed content of total | | | | | |
| amount of nitrogen (N) | | | | | |
| in dry matter (100 g) | 12.13 | g | <2.11 g | 10.02 | g |
| | | | (21.06%)< | | |
| in manure (1000 g) | 4970 | mg | <709 mg | 4198 | mg |
| | | | (16.9%)< | | |
| Analysed content of | | | | | |
| ammonium (NH₄⁺) | | | | | |
| in dry matter (100 g) | 9.17 | g | <2.25 g | 6.92 | g |
| | | | (32.5%)< | | |
| in manure (1000 g) | 3709 | mg | <810 mg | 2899 | mg |
| | | | (27.9%)< | | |
| Analysed content of urea | | | | | |
| in dry substance (100 g) | 5.69 | g | <0.56 g | 5.13 | g |
| | | | (10.9%)< | | |
| in manure (1000 g) | 1074 | mg | <71 mg | 1003 | mg |
| | | | (7.1%)< | | |
| Plant accessible | | | | | |
| nitrogen (N) | 4783 | mg | <881 mg | 3902 | mg |
| | | | (22.6%)< | | |
| Total amount of dust | | | | | |
| Personally carried sensor | 1.5 | mg/m³ | >3.6 mg/m³ | 5.1 | mg/m³ |
| | | | (240%)> | | |
| Stationary sensor | 1.2 | mg/M³ | >1.5 mg/m³ | 2.7 | mg/m³ |
| | | | (125%)> | | |
| Respiratory dust | | | | | |
| Personally carried sensor | 0.42 | mg/m³ | >2.08 mg/m³ | 2.5 | mg/m³ |
| | | | (495%)> | | |
| Stationary sensor | 0.28 | mg/m³ | >0.72 mg/m³ | 1.0 | mg/m³ |
| | | | (257%)> | | |
| Growth of 21 pigs, | | | | | |
| pr. pig pr. day | 964 | g | <157 g | 807 | g |
| | | | (19.5%)< | | |
| Size correction | 964 | g | <107 g | 857 | g |
| | | | (12.5%)< | | |
| Lung capacity, personnel | | | | | |

| <15 ppm | | | 680-700 l/h | |
|---|---|---|---|---|
| >15 ppm | >700 | l/h | 550 | l/h |

Apart form tests made in a pen, further tests made in the fields have been conducted in the northern part of Denmark between 17 May. 2001 and 24 Jul. 2001. Two basins were established in the fields, each basin having a length of about 17 m, a width of about 3 m and a depth in average of 0.5 m. The one basin, the test basin, is a basin for conducting tests of manure treated according to the method of the invention, and the other basin, the reference basin, is a basin for conducting tests of manure not treated at all. The results show that the amount of ammonium in the test basin is much greater than in the reference basin meaning the nutritional value to plants is much greater in manure treated according to the invention than in manure not treated at all. Also the results show that the evaporation of ammonia from the test basin is much less than from the reference basin.

Test results of test in the field:

| | Test basin | Difference | Reference basin |
|---|---|---|---|
| | g/100 g | g/100 g | g/100 g |
| Total amount of N | | | |
| (initially) | 9.70 | 2.72 | 6.98 |
| (after 68 days) | 12.88 | 8.47 | 4.41 |
| Amount of ammonium, NH₄⁺ | | | |
| (initially) | 8.68 | 4.15 | 4.53 |
| (after 68 days) | 11.07 | 10.22 | 0.85 |

Further tests showed that during the 68 days no evaporation of ammonia at all occurred in the test basin, while evaporation did occur in the reference basin. This significantly shows that the total amount of nitrogen in the manure treated by the method according to the invention is still present in the manure as in-organic bound nitrogen even after having been let into the fields, while the amount of nitrogen of the not treated manure is reduced when being let into the fields.

Further test results in the fields shows that an amount of 33 tons of not treated manure results in 65,67 hkg of grain per hectare in a field of wheat. However, an amount of only 20 tons of manure treated by means of the method of acidifying and oxidising according to the invention results in 73,33 hkg of grain per hectare in the same field of wheat.

1. A method of reducing emission of ammonia from animal manure said manure containing ions of NH₄⁺ and having a pH value above 7 and said manure being added an acid compound having a pH value below 7, and where the acid compound is added to the manure after the manure has been led from a manure gutter to a collection vessel, and said manure furthermore being added oxygen after the manure has been led from the manure gutter, and where the acidified and oxidized manure having been added both the acid compound and the oxygen afterwards is being led back to the manure gutters.

2. A method according to claim 1, where the acid compound is added to the manure in the collection vessel after the manure has been led to the collection vessel and before the manure is led back to the manure gutters.

3. A method according to claim 1 or claim 2, where the oxygen is added to the manure after the manure has been led from the collection vessel and before the manure is led back to the a manure gutters.

4. A method according to any of claims 1 or claim 2, where the acidified and oxidized manure being led to the manure gutters has a pH value of between 3.0 and 7.0, preferably between 4.0 and 6.0, more preferably a pH value of 5.5.

5. A method according to any of claim 1 or claim 3, where the acidified and oxidized manure being led to the manure gutters has a content of oxygen of between 0.4 mg/l and 5.0 mg/l, preferably between 0.5 mg/l and 2.0 mg/l, more preferably 1.0 mg/l.

6. A method according to claim 1, claim 2 or claim 4, where the acid compound is selected among sulphuric acid (H₂SO₄), hydrochloric acid (HCl), acetic acid (CH₃COOH), formic acid (HCOOH), sodium-hydrogen-sulphate (NaHSO₄), potassium-hydrogen-sulphate (KHSO₄) and sodium-hydrogen-sulphite (NaHSO₃).

7. A method according to claim 1, claim 2, claim 4 or claim 6, where manure from the manure gutters is mixed with manure, that has been initially collected in the collection vessel and subsequently has been acidified and oxidized, and where the mixture of the non-acidified and the non-oxidized manure together with acidified and the oxidized manure is recycled in such a way that a number of times the mixture is being led from the manure gutters to the collection vessel for adding of the acid compound and adding of the oxygen and subsequently is being led from the collecting vessel to the manure gutters.

8. A method according to claim 7, where an amount of acid compound added before the mixture is being led from the collecting vessel to the manure gutters is decreasing relative to the number of times that the mixture has been led from the manure gutters to the collection vessel.

9. A method for reducing emission of ammonia from animal manure, said manure containing ions of NH₄ and having a pH value above 7, and where water of a pH value of about 7 is added an acid compound having a pH value below 7, and where the acidified water is led to a manuring area of an animal stable.

10. A plant for reducing emission of ammonia from animal manure, said plant comprising a collection vessel for collecting animal manure being led from manure gutters in a stable, and said plant furthermore comprising acid supply means for adding an acid compound to the manure and oxygen supply means for adding oxygen to the manure, and said plant furthermore comprising distribution means for distributing the acidified and oxidized manure back to the manure gutters in the stable and which distribution means is situated between the collecting vessel and a number of outlets of the distributing means.

11. A plant according to claim 10, where the acid supply means is provided for adding the acid compound to the collection vessel and preferably to the bottom of the collecting vessel.

12. A plant according to claim 10 or claim 11, where the oxygen supply means is provided for adding the oxygen to the distribution means situated after the collecting vessel.

13. A plant according to claim 11, where the acid supply means comprises a valve being installed between a reservoir for the acid compound and the collecting vessel for the manure, and where adding of the acid compound from the reservoir through the valve to the collecting vessel is regulated by a pH sensor situated in the collecting vessel.

14. A plant according to claim 12, where the oxygen supply means comprises an ejector being installed in the distribution means between the collecting vessel for the manure and the number of outlets for the distribution means, and where adding of the oxygen through the ejector to the distribution means is established when acidified manure flows through the distribution means.

15. A plant according to claim 12, where the oxygen supply means comprises a compressor being provided in connection with the distribution means between the collecting vessel for the manure and the number of outlets for the distribution means, and where adding of the oxygen by the compressor to the distribution means is established when acidified manure flows through the distribution means.

16. A plant according to any of claims 10-15, where the distribution means comprises a pump installed in the collecting vessel, preferably an emerged pump being installed at the bottom of the collecting vessel.

17. A plant according to any of claims 10-16, where the distribution means comprises outlets being submerged below a surface of liquid manure being gathered and standing a certain depth in the manure gutters.

18. A plant according to any of claims 10-17, where the distribution means comprises a number of transfer pipes constituting passages from a main pipe of the distribution means to the outlets of the distribution means, and where the transfer pipes extend from the main pipe upwards along a curve to an upper level and extend from the upper level downwards along a curve to the outlets.

19. A plant according to claim 18, where the transfer pipes lead from an upper part of a circumference of the main pipe, the main pipe extending in a substantially horizontal plane, and the transfer pipes extending in a substantially vertical plane.

20. A plant according to claim 18 or claim 19, where the upper level of all the number of transfer pipes lie in the one and same horizontal plane so that the liquid pressure of the acidified and oxidized manure in the outlets is the one and same.

21. A plant for reducing emission of ammonia from animal manure, said plant comprising vesselacid supply means for adding an acid compound to water, and said plant furthermore comprising distribution means for distributing the acidified water to a manuring area of the stable and which distribution means is situated between an inlet of water and a number of outlets of the distributing means.

22. A plant according to claim 21, where the distribution means comprises a main water pipe and outlets connected to the main water pipe, and where the main water pipe extend above pens in the stable, preferably at a level above the height of a man, and that the outlets are capable of flushing the water out onto the floor of the pen.

23. Use of a plant according to any of claims 10-20 for reducing the emission of ammonia from animal manure in manure gutters in a stable.

24. Use of a plant according to any of claims 10-20 for reducing the emission of ammonia from animal manure on manuring areas in a stable.

25. Use of a plant according to any of claims 10-20 for increasing the conversion of organic nitrogen-containing compounds to in-organic nitrogen-containing compounds.
